(19) United States
(12) Patent Application Publication
(10) Pub. No.: US 2018/0175933 A1
(43) Pub. Date: Jun. 21, 2018

(54) COMMUNICATION DEVICE, COMMUNICATION SYSTEM AND COMMUNICATION METHOD FOR TRANSMITTING OPTICAL SIGNAL

(71) Applicant: FUJITSU LIMITED, Kawasaki-shi (JP)

(72) Inventors: Yoshitaka Nomura, Shinagawa (JP); Hisao Nakashima, Kawasaki (JP); Tomofumi Oyama, Kawasaki (JP); YUICHI AKIYAMA, Kawasaki (JP); Takeshi Hoshida, Kawasaki (JP)

(73) Assignee: FUJITSU LIMITED, Kawasaki-shi (JP)

(21) Appl. No.: 15/842,218

(22) Filed: Dec. 14, 2017

(30) Foreign Application Priority Data
Dec. 19, 2016 (JP) 2016-245355

(51) Int. Cl. H04B 10/079; H04B 10/50

(52) U.S. Cl. CPC H04B 10/079; H04B 10/50

(57) ABSTRACT

A communication device includes: a spectrum controller and optical signal generator. The spectrum controller controls a shape of a spectrum of a first signal. The optical signal generator generates an optical signal based on the first signal, the shape of the spectrum of the first signal being controlled by the spectrum controller. The spectrum controller controls the shape of the spectrum of the first signal according to a second signal.

### CROSS-REFERENCE TO RELATED APPLICATION

This application is based upon and claims the benefit of priority of the prior Japanese Patent Application No. 2016-245355, filed on Dec. 19, 2016, the entire contents of which are incorporated herein by reference.

### FIELD

The embodiments discussed herein are related to a communication device, a communication system and a communication method for transmitting an optical signal.

### BACKGROUND

Due to the spread of the Internet and mobile communications, a communication capacity of a network has increased. As one example of a technology for increasing the communication capacity, digital coherent transmission has been put into practical use.

In a digital coherent transmission system, setting information for controlling communications is shared between a transmitter and a receiver. As an example, the transmitter and the receiver need to share information indicating a bit rate, information indicating a modulation format, and the like. Therefore, the transmitter transmits a control signal in addition to a data signal to the receiver.

The control signal is transmitted from the transmitter to the receiver by using, for example, an optical path that is different from the optical path of the data signal. In this case, a communication resource (for example, a frequency) needs to be used to transmit the control signal, and therefore the utilization efficiency of the communication resource is reduced. Accordingly, a method for transmitting the data signal and the control signal via a single optical path has been considered. As an example, a method for superimposing the control signal onto an optical signal that transmits the data signal by using a frequency modulation has been proposed.

A method for recovering a control signal that is transmitted together with a data signal in an optical communication system using digital coherent detection has been proposed (for example, Japanese Laid-open Patent Publication No. 2010-178090). In addition, a technology for assuring security in a physical layer while transmitting a data signal and a control signal in the same wavelength band has been proposed (Japanese Laid-open Patent Publication No. 2008-199106).

In a convention technology, in a case in which a data signal and a control signal are transmitted via a single optical path, a dedicated circuit to superimpose the control signal onto an optical signal is needed. As an example, in a case in which a control signal is superimposed onto an optical signal according to a frequency modulation, a circuit configured to control a carrier frequency of the optical signal according to the control signal is used. Accordingly, the size of a circuit configured to process each optical path may increase. This problem does not arise only in a system that transmits a data signal and a control signal via a single optical path, but may also arise in a system that transmits arbitrary plural signals via a single optical path.

### SUMMARY

According to an aspect of the present invention, a communication device includes: a spectrum controller configured to control a shape of a spectrum of a first signal; and an optical signal generator configured to generate an optical signal based on the first signal, the shape of the spectrum of the first signal being controlled by the spectrum controller. The spectrum controller controls the shape of the spectrum of the first signal according to a second signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a communication system.

FIG. 2 illustrates an example of a transmitter circuit implemented in on a communication device.

FIGS. 3A-3C are diagrams explaining the roll-off ratio of a Nyquist filter.

FIG. 4 illustrates an example of a filter controller.

FIG. 5 illustrates an example of a filter coefficient memory.

FIG. 6 illustrates an example of processing for changing a roll-off ratio according to a control signal.

FIG. 7 illustrates an example of a roll-off ratio calculator.

FIG. 8 illustrates an example of a receiver circuit implemented in a communication device.

FIG. 9 illustrates a first example of a control signal detector implemented in the receiver circuit illustrated in FIG. 8.

FIG. 10 illustrates an example of the spectrum of an output signal of a photodetector.

FIG. 11 illustrates a second example of a control signal detector implemented in the receiver circuit illustrated in FIG. 8.

FIG. 12 illustrates a third example of a control signal detector implemented in the receiver circuit illustrated in FIG. 8.

FIG. 13 illustrates another example of the spectrum of an output signal of a photodetector.

FIG. 14 illustrates another example of a receiver circuit implemented in a communication device.

FIG. 15 illustrates a first example of a control signal detector implemented in the receiver circuit illustrated in FIG. 14.

FIG. 16 is an example of a timing chart illustrating a correlation value with respect to a control signal.

FIG. 17 illustrates a second example of a control signal detector implemented in the receiver circuit illustrated in FIG. 14.

FIG. 18 illustrates an example of the measurement of a spectral width according to a second embodiment.

FIG. 19 is an example of a timing chart illustrating a spectral width with respect to a control signal.

FIG. 20 illustrates a third example of a control signal detector implemented in the receiver circuit illustrated in FIG. 14.

FIG. 21 illustrates an example of power measurement in the third example.

FIG. 22 is an example of a timing chart illustrating signal power with respect to a control signal.

### DESCRIPTION OF EMBODIMENTS

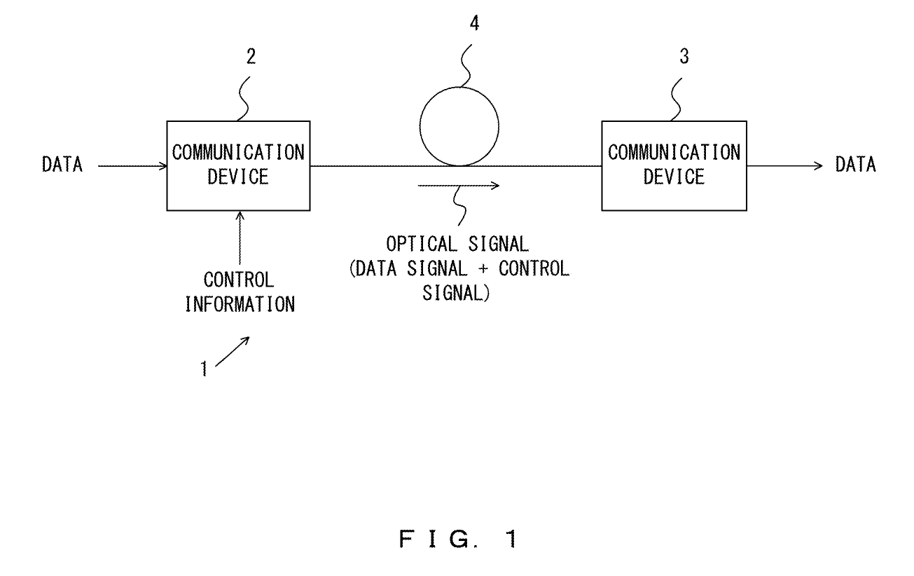

FIG. 1 illustrates an example of a communication system according to the embodiments. A communication system 1 according to the embodiments includes a communication device 2 and a communication device 3, as illustrated in FIG. 1. The communication device 2 and the communication device 3 are connected by an optical fiber link 4. In the description below, assume that data is transmitted from the communication device 2 to the communication device 3.

Data and control information are given to the communication device 2. The communication device 2 generates an optical signal that transmits a data signal indicating the data and a control signal indicating the control information. This optical signal is transmitted from the communication device 2 to the communication device 3 via the optical fiber link 4. Namely, the data signal and the control signal are transmitted from the communication device 2 to the communication device 3 via a single optical path. The control information controls communication between the communication device 2 and the communication device 3. As an example, the control information includes information indicating the bit rate of transmitted data, information indicating a modulation format, and the like.

The communication device 3 demodulates the received optical signal so as to recover the data. In addition, the communication device 3 extracts the control signal from the received optical signal so as to recover the control information. The communication device 3 configures a receiver circuit and/or a receiving function according to the recovered control information.

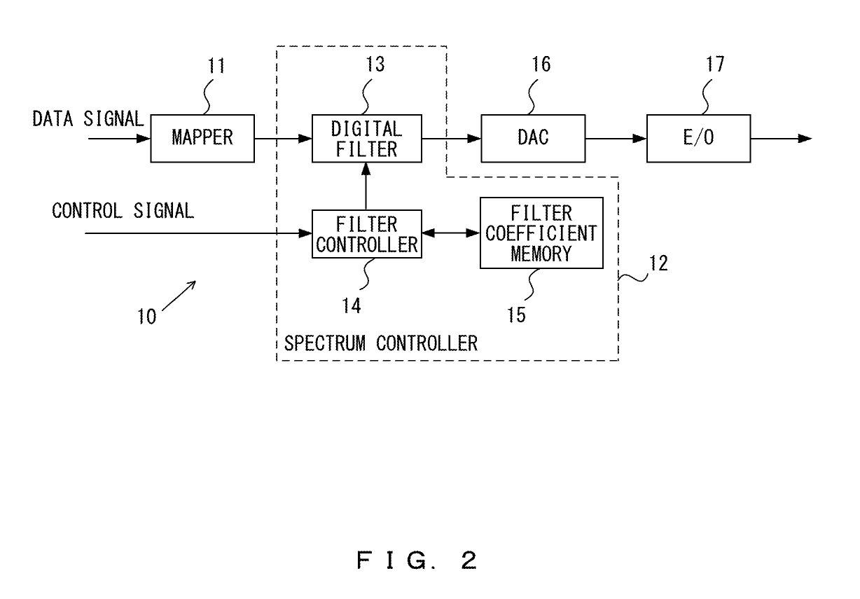

FIG. 2 illustrates an example of a transmitter circuit implemented in a communication device according to the embodiments. This transmitter circuit is implemented, for example, in the communication device 2 illustrated in FIG. 1.

A transmitter circuit 10 includes a mapper 11, a spectrum controller 12, a D/A (Digital-to-Analog) converter (DAC) 16, and an optical signal generator (E/O (Electrical-to-Optical) converter) 17, as illustrated in FIG. 2. A data signal and a control signal are given to the transmitter circuit 10. The data signal is generated, for example, by a user or a client. The control signal is given, for example, from a network management system.

The mapper 11 converts the data signal according to a modulation format. Namely, a symbol stream is generated from a bit stream. As an example, when the modulation format is QPSK, each symbol is generated from data of 2 bits. Each of the symbols is expressed, for example, by an I-component and a Q-component.

The spectrum controller 12 controls the shape of the spectrum of the modulated data signal. In this example, the spectrum controller 12 can control the spectrum of the data signal to be in a Nyquist shape. In this case, the spectrum controller 12 includes a Nyquist filter (or a raised cosine filter), and performs Nyquist filtering on the data signal. When the spectrum of the data signal is controlled to be in a Nyquist shape, interference between symbols is suppressed.

The spectrum controller 12 includes a digital filter 13, a filter controller 14, and a filter coefficient memory 15 in this example. The digital filter 13 filters the data signal according to filter coefficients given from the filter controller 14. Namely, the digital filter 13 can control the shape of the spectrum of the data signal in accordance with the filter coefficients given from the filter controller 14. The digital filter 13 is implemented by an FIR filter in this example. In addition, the digital filter 13 operates as a Nyquist filter (or a raised cosine filter).

The filter controller 14 controls the filter coefficients of the digital filter 13. Namely, the filter controller 14 determines filter coefficients in such a way that the digital filter 13 operates as a Nyquist filter for the data signal. The filter coefficient memory 15 stores filter coefficients that cause the digital filter 13 to operate as the Nyquist filter. Accordingly, the filter controller 14 can obtain necessary filter coefficients from the filter coefficient memory 15, and can provide the filter coefficients to the digital filter 13.

The filter controller 14 is implemented, for example, by a processor system including a processor and a memory. In this case, the processor system can control the filter coefficients of the digital filter 13 by executing a given program. The filter controller 14 may be implemented by a hardware circuit. Alternatively, the filter controller 14 may be implemented by a combination of the processor system and a hardware circuit.

The D/A converter 16 converts the data signal for which the shape of a spectrum has been controlled by the spectrum controller 12 into an analog signal. An analog data signal output from the D/A converter 16 may be amplified by an amplifier. The optical signal generator 17 generates an optical signal according to the analog data signal. As an example, in a case in which the optical signal generator 17 generates an optical signal in direct modulation, a laser light source is driven by the data signal. In a case in which the optical signal generator 17 includes a light source and an optical modulator, the optical modulator modulates continuous-wave light output from the light source by using the data signal so as to generate an optical signal.

In the transmitter circuit 10 described above, the spectrum controller 12 can control the shape of the spectrum of a data signal according to a control signal. Namely, when the control signal is given to the transmitter circuit 10, the spectrum controller 12 controls the shape of the spectrum of the data signal according to the control signal. In this example, the spectrum controller 12 controls the shape of the spectrum of the data signal by controlling the roll-off ratio of the digital filter 13 in accordance with the control signal.

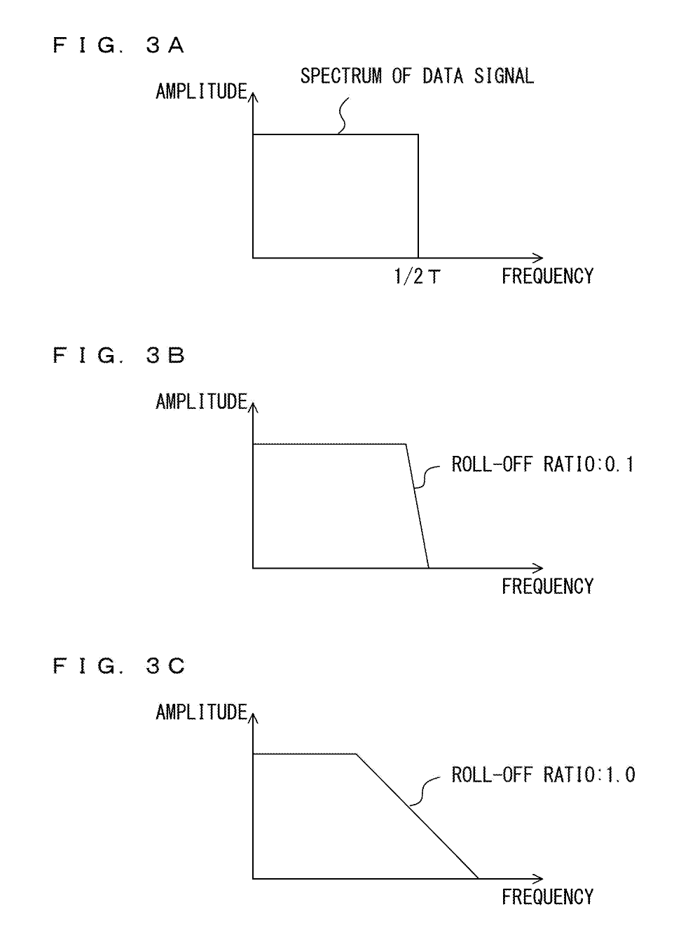

FIGS. 3A-3C are diagrams explaining the roll-off ratio of a Nyquist filter. The Nyquist filter has a cutoff frequency that corresponds to a symbol interval T of a data signal. Specifically, when the symbol interval of the data signal is T seconds, the cutoff frequency of the Nyquist filter is ½T, as illustrated in FIG. 3A.

The characteristics of the Nyquist filter are specified by a roll-off ratio. When the roll-off ratio is low, the end of the spectrum of an output signal of the Nyquist filter is steep with respect to a frequency, as illustrated in FIG. 3B. When the roll-off ratio is high, the end of the spectrum of the output signal of the Nyquist filter is gradual with respect to the frequency, as illustrated in FIG. 3C.

The spectrum controller 12 controls the roll-off ratio of the digital filter 13 according to the control signal. In this example, when the control signal is “0”, the roll-off ratio is controlled to 0.1, and when the control signal is “1”, the roll-off ratio is controlled to 1.0.

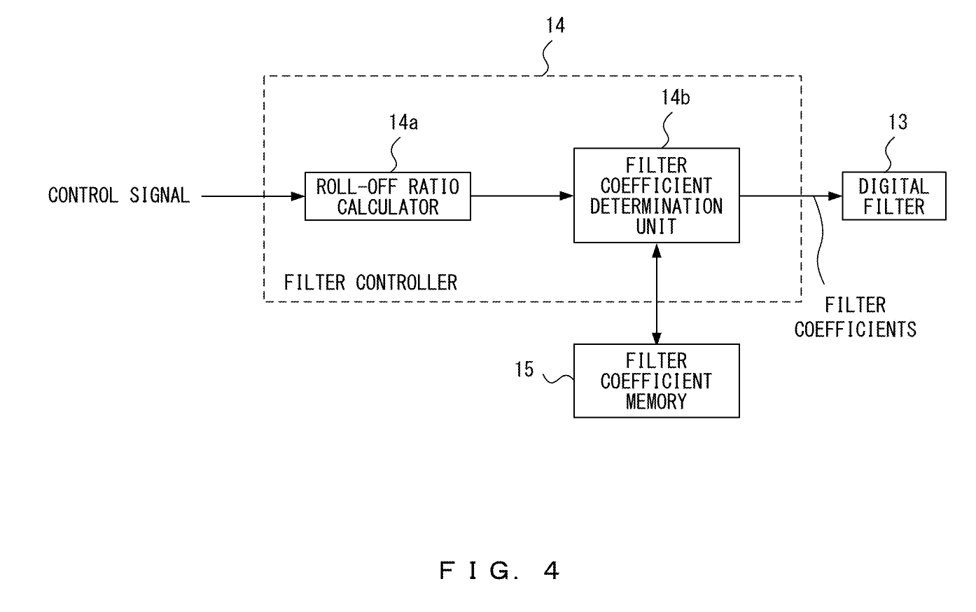

FIG. 4 illustrates an example of the filter controller 14. In this example, the filter controller 14 includes a roll-off ratio calculator 14a and a filter coefficient determination unit 14b. The roll-off ratio calculator 14a calculates a roll-off ratio according to a control signal. In the example above, the roll-off ratio calculator 14a outputs a roll-off ratio of 0.1 when the control signal is “0”, and outputs a roll-off ratio of 1.0 when the control signal is “1”. The filter coefficient determination unit 14b determines filter coefficients that correspond to the calculated roll-off ratio. In this example, the filter coefficient determination unit 14b obtains the filter coefficients that correspond to the calculated roll-off ratio from the filter coefficient memory 15.

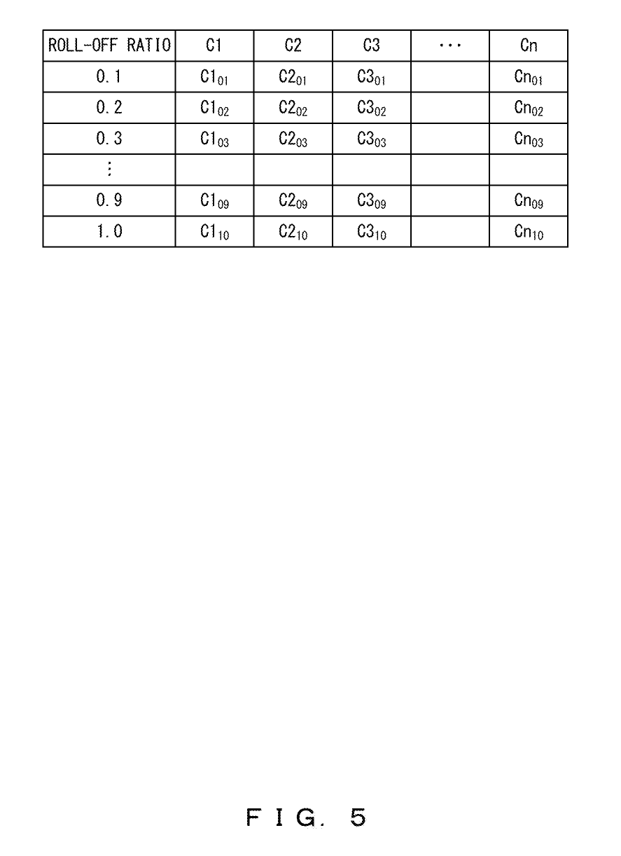

FIG. 5 illustrates an example of the filter coefficient memory 15. The filter coefficient memory 15 stores filter coefficients that cause the digital filter 13 to operate as a Nyquist filter. Specifically, the filter coefficient memory 15 stores filter coefficients for achieving a specified roll-off ratio. In this example, assume that the number of taps of the digital filter 13 is n. In this case, the digital filter 13 processes an input signal according to n filter coefficients C1 to Cn. Accordingly, the filter coefficient memory 15 stores filter coefficients C1 to Cn with respect to the roll-off ratio. As an example, filter coefficients C1₀₁ to Cn₀₁ are stored with respect to a roll-off ratio of 0.1, and filter coefficients C1₁₀ to Cn₁₀ are stored with respect to a roll-off ratio of 1.0.

Assume that filter coefficients C1 to Cn stored in the filter coefficient memory 15 are prepared in advance by performing measurement or simulation. The filter coefficients may be prepared for each of the combinations of a bit rate and a modulation format.

The filter coefficient determination unit 14b obtains, from the filter coefficient memory 15, filter coefficients that correspond to the roll-off ratio calculated by the roll-off ratio calculator 14a. The filter coefficient determination unit 14b gives the filter coefficients obtained from the filter coefficient memory 15 to the digital filter 13. The digital filter 13 processes an input signal by using the given filter coefficients.

As an example, when the control signal is “0”, “roll-off ratio=0.1” is obtained by the roll-off ratio calculator 14a. In this case, the filter coefficient determination unit 14b obtains filter coefficients C1₀₁ to Cn₀₁ from the filter coefficient memory 15, and gives the filter coefficients to the digital filter 13. The digital filter 13 processes a data signal by using filter coefficients C1₀₁ to Cn₀₁. Stated another way, Nyquist filtering is performed on the data signal by using filter coefficients C1₀₁ to Cn₀₁. By doing this, the spectrum of the data signal is controlled to be in the shape illustrated in FIG. 3B. Accordingly, the spectrum of an optical signal output from the transmitter circuit 10 is also controlled to be in the shape illustrated in FIG. 3B.

When the control signal is “1”, “roll-off ratio=1.0” is obtained by the roll-off ratio calculator 14a. In this case, the filter coefficient determination unit 14b obtains filter coefficients C1₁₀ to Cn₁₀ from the filter coefficient memory 15, and gives the filter coefficients to the digital filter 13. The digital filter 13 processes a data signal by using C1₁₀ to Cn₁₀. Stated another way, Nyquist filtering is performed on the data signal by using filter coefficients C1₁₀ to Cn₁₀. By doing this, the spectrum of the data signal is controlled to be in the shape illustrated in FIG. 3C. Accordingly, the spectrum of an optical signal output from the transmitter circuit 10 is also controlled to be in the shape illustrated in FIG. 3C.

As described above, the shape of the spectrum of a data signal is controlled according to a control signal. By doing this, the shape of the spectrum of an optical signal output from the transmitter circuit 10 is also controlled according to the control signal. Namely, the control signal is converted into a spectral shape, and is transmitted. Accordingly, the transmitter circuit 10 can transmit the data signal and the control signal via a single optical path.

The control signal is superimposed onto the optical signal by using the digital filter 13, which operates as a Nyquist filter. The Nyquist filter has been implemented in many existing transmitter circuits. Accordingly, in a transmitter circuit equipped with a digital filter such as a Nyquist filter, the control signal can be superimposed onto the optical filter without adding a dedicated circuit. Namely, according to the embodiment illustrated in FIG. 2, the size of a circuit of a communication device can be reduced in comparison with a configuration in which the control signal is superimposed onto the optical signal according to a frequency modulation.

In the configuration in which the control signal is superimposed onto the optical signal according to a frequency modulation, the center frequency of the spectrum of the optical signal changes according to the control signal. In this configuration, the shape of the spectrum of the optical signal does not substantially change according to the control signal.

As described above, when the state of a control signal changes, a roll-off ratio also changes, and the spectral shape of an optical signal output from the transmitter circuit 10 also changes. However, when the spectral shape of the optical signal output from the transmitter circuit 10 rapidly changes, a receiver may fail to appropriately demodulate a data signal. As an example, many receivers that perform digital coherent detection include an adaptive equalizer that equalizes the shape of a received signal. Here, a parameter that specifies the operation state of the adaptive equalizer is periodically updated according to the state of the received signal. Therefore, when the spectral shape of a received optical signal rapidly changes, the updating of the parameter of the adaptive equalizer may be delayed, and the data signal may fail to be appropriately demodulated.

Accordingly, it is preferable that, when the state of the control signal changes, the filter controller 14 change the roll-off ratio of the digital filter 13 in stages. Namely, when the control signal changes from “0” to “1”, the filter controller 14 changes the roll-off ratio from 0.1 to 1.0 in stages via one or more intermediate roll-off ratios. When the control signal changes from “1” to “0”, the filter controller 14 changes the roll-off ratio from 1.0 to 0.1 in stages via one or more intermediate roll-off ratios. The speed of a change in the roll-off ratio is determined, for example, so as to be lower than the update speed of an equalizer implemented in the receiver.

The roll-off ratio is one example of an index indicating the characteristics of the digital filter. Accordingly, when the roll-off ratio is changed in stages via one or more intermediate roll-off ratios, the characteristics of the digital filter also change in stages via one or more intermediate states. That is to say, when the control signal changes from “1” to “0” or when the control signal changes from “0” to “1”, the filter controller 14 changes the characteristics of the digital filter 13 in stages via one or more intermediate states.

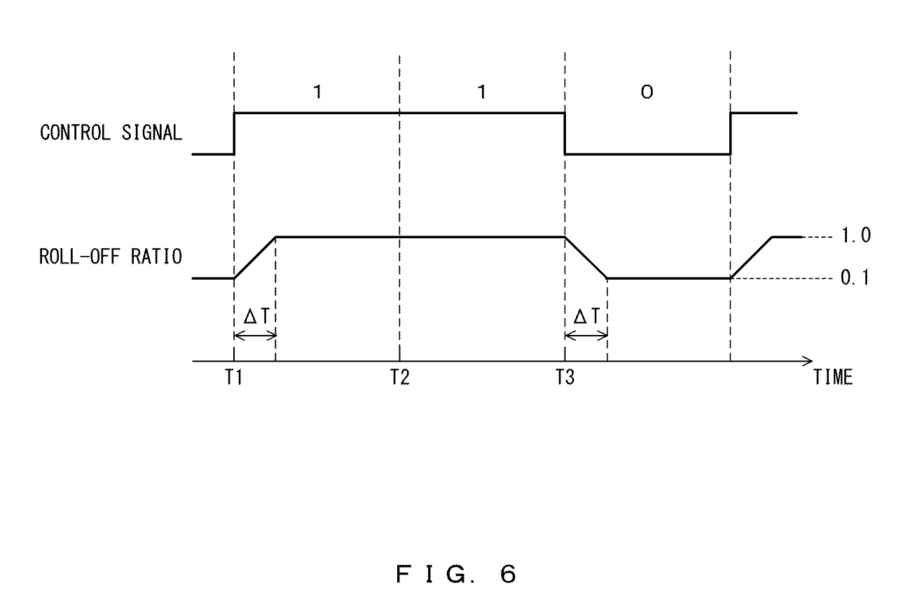

FIG. 6 illustrates an example of processing for changing a roll-off ratio according to a control signal. In this example, before time T1, the control signal is “0”, and the roll-off ratio is 0.1. At time T1, the control signal changes from “0” to “1”. During a period from time T1 to time T3, the control signal is “1”. At time T3, the control signal changes from “1” to “0”.

At time T1, when the control signal changes from “0” to “1”, the roll-off ratio increases from 0.1 to 1.0 in stages. After the roll-off ratio reaches 1.0, the roll-off ratio is maintained at the same value until the control signal changes at time T3. At time T3, when the control signal changes from “1” to “0”, the roll-off ratio decreases from 1.0 to 0.1 in stages. The time ΔT needed for the roll-off ratio to change between 0.1 and 1.0 is determined, for example, according to the update speed of the equalizer implemented in the receiver, as described above.

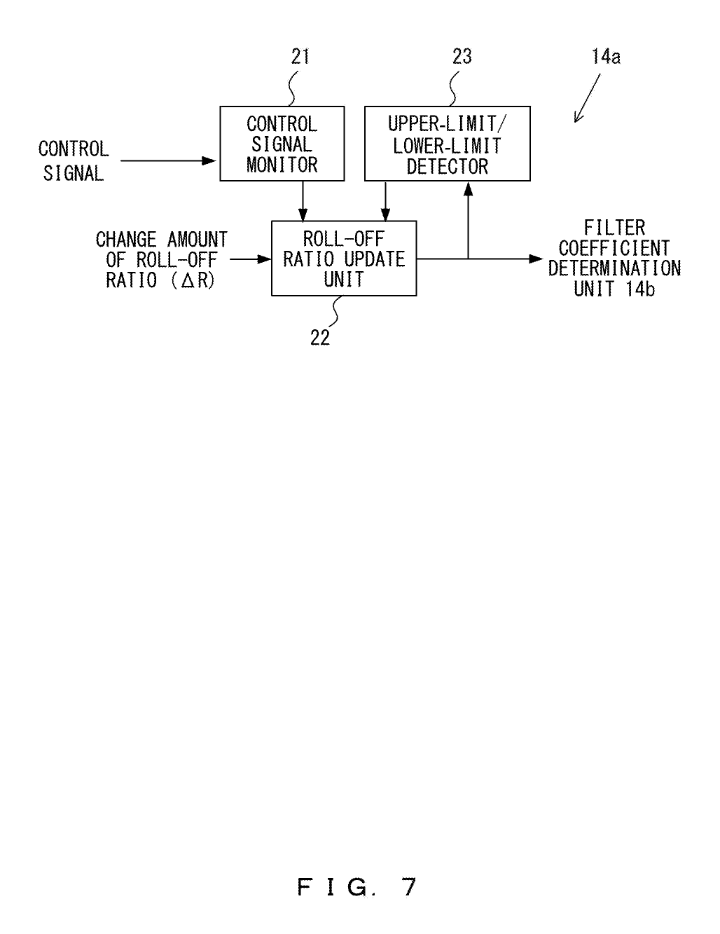

FIG. 7 illustrates an example of the roll-off ratio calculator 14a. In this example, the roll-off ratio calculator 14a includes a control signal monitor 21, a roll-off ratio update unit 22, and an upper-limit/lower-limit detector 23. Assume that the change amount ΔR of the roll-off ratio is determined in advance. As an example, the change amount ΔR is 0.1.

The control signal monitor 21 monitors a change in the state of a control signal. When the state of the control signal changes, the control signal monitor 21 reports a monitor result to the roll-off ratio update unit 22. Specifically, when the control signal changes from “0” to “1”, the control signal monitor 21 outputs a rising-edge detection signal. When the control signal changes from “1” to “0”, the control signal monitor 21 outputs a falling-edge detection signal.

Upon receipt of a report from the control signal monitor 21, the roll-off ratio update unit 22 updates the roll-off ratio. The roll-off ratio is updated according to the change amount ΔR. The upper-limit/lower-limit detector 23 determines whether the roll-off ratio updated by the roll-off ratio update unit 22 has reached an upper limit value or a lower limit value that has been determined in advance. When the updated roll-off ratio has reached the upper limit value or the lower limit value, the upper-limit/lower-limit detector 23 outputs an update termination instruction. In this example, the upper limit value and the lower limit value are 1.0 and 0.1, respectively.

As an example, processing that is performed by the roll-off ratio calculator 14a when the control signal changes from “0” to “1” is described. During a period when the control signal is “0”, the roll-off ratio is maintained to 0.1. When the control signal changes from “0” to “1”, a rising-edge detection signal is output from the control signal monitor 21. The roll-off ratio update unit 22 adds the change amount ΔR to a current roll-off ratio. By doing this, the roll-off ratio is updated from 0.1 to 0.2. The updated roll-off ratio has not yet reached an upper limit value. Accordingly, the roll-off ratio update unit 22 further updates the roll-off ratio. Namely, the roll-off ratio is updated from 0.2 to 0.3.

The update of the roll-off ratio is repeatedly performed until the updated roll-off ratio reaches the upper limit value. Stated another way, the roll off-ratio increases by 0.1 at each update operation. When the updated roll-off ratio reaches the upper limit value (namely, 1.0), the upper-limit/lower-limit detector 23 outputs an update termination instruction and the roll-off ratio update unit 22 terminates the update of the roll-off ratio.

According to the procedure above, the roll-off ratio increases from 0.1 to 1.0 in stages. When the control signal changes from “1” to “0”, the roll-off ratio decreases from 1.0 to 0.1 in stages. In this case, the roll-off ratio update unit 22 subtracts the change amount ΔR from a current roll-off ratio. A time interval of the update of the roll-off ratio may be determined, for example, according to the update speed of the equalizer implemented in the receiver.

The roll-off ratio calculated by the roll-off ratio calculator 14a is given to the filter coefficient determination unit 14b. The filter coefficient determination unit 14b obtains filter coefficients that correspond to the roll-off ratio from the filter coefficient memory 15. As an example, when the updated roll-off ratio is 0.2, the filter coefficient determination unit 14b obtains filter coefficients C1₀₂ to Cn₀₂ from the filter coefficient memory 15. When the updated roll-off ratio is 0.3, the filter coefficient determination unit 14b obtains filter coefficients C1₀₃ to Cn₀₃ from the filter coefficient memory 15.

The digital filter 13 processes the data signal according to the filter coefficients given from the filter controller 14. Accordingly, when the state of the control signal changes, the spectral shape of the optical signal output from the transmitter circuit 10 changes in stages via one or more intermediate spectral shapes.

As described above, the transmitter circuit 10 generates an optical signal that transmits a data signal. When a control signal is given, the transmitter circuit 10 superimposes the control signal onto the optical signal by changing the spectral shape of the optical signal according to the control signal.

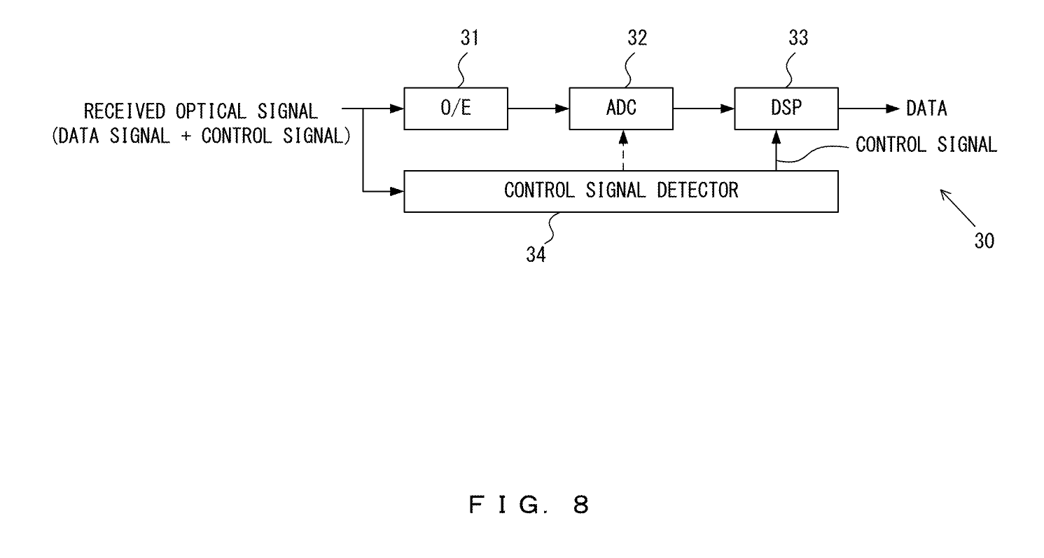

FIG. 8 illustrates an example of a receiver circuit implemented in a communication device according to the embodiments. This receiver circuit is implemented, for example, in the communication device 3 illustrated in FIG. 1.

A receiver circuit 30 includes an O/E (Optical-to-Electrical) circuit 31, an A/D (Analog-to-Digital) converter (ADC) 32, a digital signal processor (DSP) 33, and a control signal detector 34. The receiver circuit 30 receives an optical signal generated by the transmitter circuit 10 illustrated in FIG. 2. This optical signal carries a data signal and a control signal. The control signal is converted into a change in the spectral shape of the optical signal.

The O/E circuit 31 converts the received optical signal into an electric signal. In this example, the O/E circuit 31 generates an electric signal indicating electric field information of the received optical signal by coherent detection. In this case, the O/E circuit 31 includes a local oscillation light source, a 90-degree optical hybrid circuit, and the like. The A/D converter 32 converts an output signal of the O/E circuit 31 into a digital signal. Namely, a digital signal indicating the electric field information of the received optical signal is generated. The digital signal processor 33 recovers the data signal according to the digital signal indicating the electric field information of the received optical signal. The digital signal processor 33 includes, for example, an equalizer, a dispersion compensator, a frequency offset compensator, a phase recovery, a data decision unit, and the like.

The control signal detector 34 detects the control signal according to the shape of the spectrum of the received optical signal. The control signal detector 34 gives the detected control signal to the digital signal processor 33. Control information transmitted by the control signal includes information indicating a bit rate, information indicating a modulation format, and the like, as described above. The digital signal processor 33 configures a parameter for signal processing according to the control information. The A/D converter 32 may also control an operation state according to the control signal as needed.

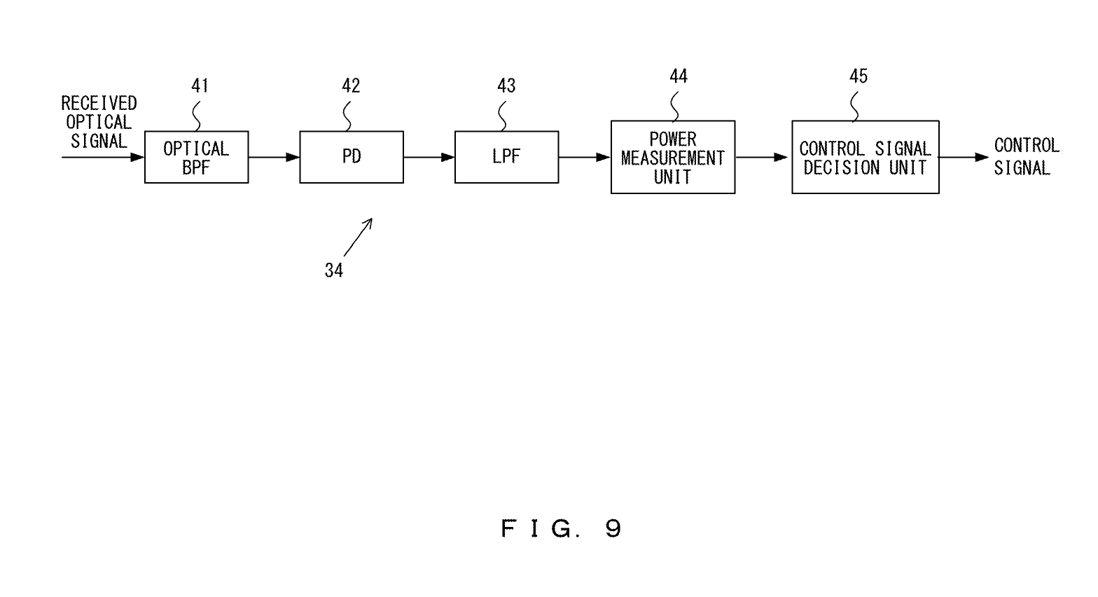

FIG. 9 illustrates a first example of the control signal detector 34 implemented in the receiver circuit 30 illustrated in FIG. 8. In the first example, the control signal detector 34 includes an optical band pass filter (BPF) 41, a photodetector (PD) 42, a low pass filter (LPF) 43, a power measurement unit 44, and a control signal decision unit 45.

The optical BPF 41 extracts an optical signal of a target frequency band from a received optical signal. Namely, the optical BPF 41 extracts a frequency band that does not include a signal component of an adjacent channel and that includes a portion of a spectrum that changes with the roll-off ratio of the received optical signal in a target channel. The photodetector 42 converts output light of the optical BPF 41 into an electric signal. The LPF 43 extracts a DC component from an output signal of the photodetector 42.

The power measurement unit 44 measures the power of an output signal of the LPF 43. The control signal decision unit 45 decides a value of each bit of the control signal in accordance with a measurement result of the power measurement unit 44. By doing this, the control signal is recovered.

Some functions of the control signal detector 34 may be implemented by a processor system including a processor and a memory. As an example, the LPF 43, the power measurement unit 44, and the control signal decision unit 45 may be implemented by the processor system. In addition, the power measurement unit 44 and the control signal decision unit 45 may be implemented by the processor system. Further, only the control signal decision unit 45 may be implemented by the processor system.

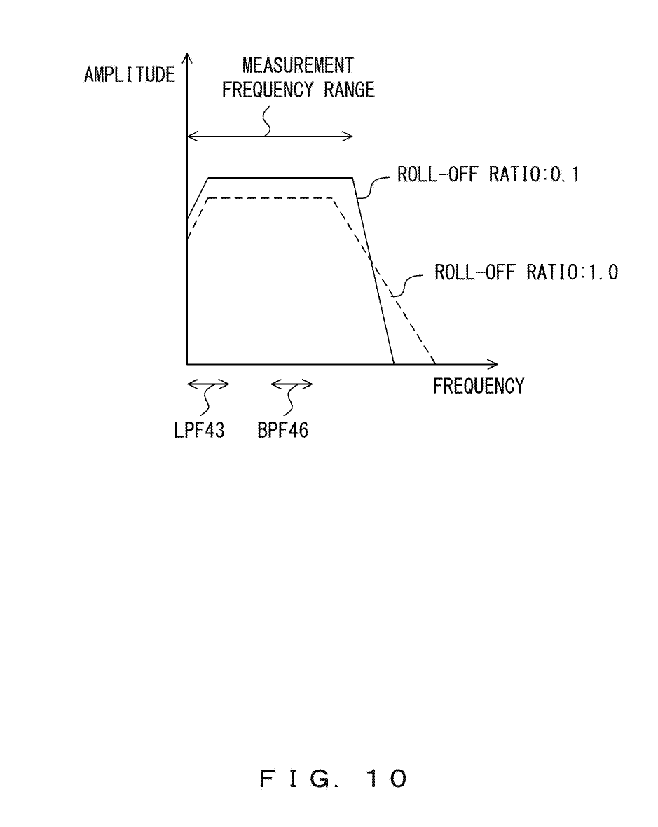

FIG. 10 illustrates an example of the spectrum of an output signal of the photodetector 42 in the first example. An optical signal is generated by the transmitter circuit 10 illustrated in FIG. 2.

The spectrum of a data signal changes according to the roll-off ratio of the digital filter 13 in the transmitter circuit 10. Specifically, in a range in which a frequency is lower than a specified frequency (for example, ½T in FIG. 3A), as the roll-off ratio decreases, an amplitude increases. Hereinafter, this frequency range may be referred to as a “measurement frequency range”.

The control signal detector 34 detects a control signal by measuring the power of a data signal in the measurement frequency range. In the example illustrated in FIG. 9, by measuring the power of an output signal of the LPF 43, a value of each bit of the control signal is detected. As an example, when the power of the output signal of the LPF 43 is greater than a specified threshold, the control signal decision unit 45 decides that the roll-off ratio is 0.1 and that the control signal is “0”. When the power of the output signal of the LPF 43 is smaller than the specified threshold, the control signal decision unit 45 decides that the roll-off ratio is 1.0 and that the control signal is “1”. Assume that the threshold is determined in advance by performing measurement, simulation, or the like.

As described above, the control signal detector 34 detects a value of each of the bits of the control signal by measuring the power of a received signal. The control signal detected by the control signal detector 34 is given to the digital signal processor 33. Alternatively, the control signal detector 34 may recover control information from the detected control signal, and may give the recovered control information to the digital signal processor 33.

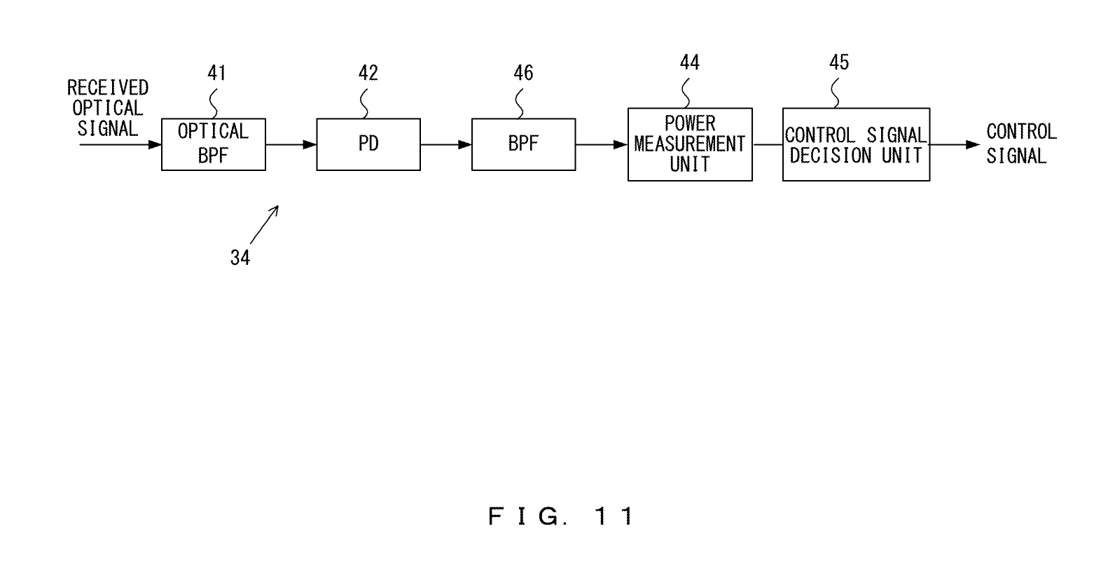

FIG. 11 illustrates a second example of the control signal detector 34 implemented in the receiver circuit 30 illustrated in FIG. 8. In the second example, the control signal detector 34 includes an optical BPF 41, a photodetector (PD) 42, a band pass filter (BPF) 46, a power measurement unit 44, and a control signal decision unit 45. The optical BPF 41, the photodetector 42, the power measurement unit 44, and the control signal decision unit 45 are substantially the same in the first example and the second example. The optical BPF 41 may be configured to remove only a signal of an adjacent channel. The description below is given under the assumption of a case in which the optical BPF 41 in the second example is the same as that in the first example.

In the second example, an output signal of the photodetector 42 is filtered by the BPF 46. The power measurement unit 44 measures the power of an output signal of the BPF 46. Here, the passband of the BPF 46 is specified within the measurement frequency range, as illustrated in FIG. 10. Accordingly, similarly to the output signal of the BPF 43 in the first example, the power of the output signal of the BPF 46 also changes depending on the roll-off ratio. Accordingly, the control signal decision unit 45 can detect the control signal according to the output signal of the BPF 46. As described above, in the second example, the control signal is detected according to a frequency component excluding a DC frequency component.

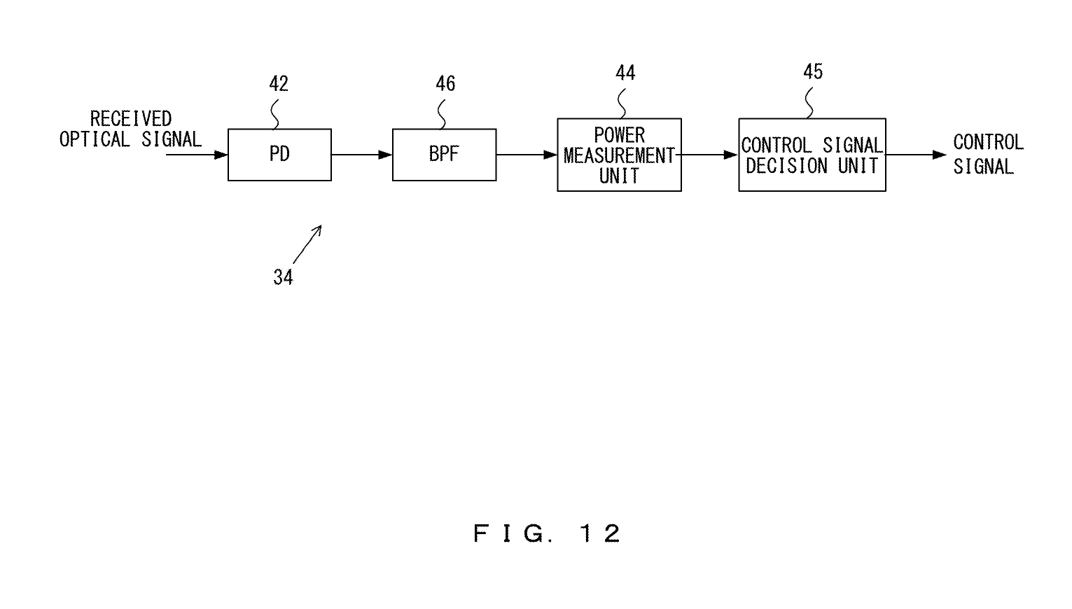

FIG. 12 illustrates a third example of the control signal detector 34 implemented in the receiver circuit 30 illustrated in FIG. 8. The control signal detector 34 in the third example is applied, for example, to a communication system in which no other spectra (for example, no adjacent channels) exist around a target channel. Accordingly, the control signal detector 34 in the third example does not need to include an optical BPF 41 configured to extract a target frequency band. The photodetector 42, the BPF 46, the power measurement unit 44, and the control signal decision unit 45 are substantially the same in the second example and the third example.

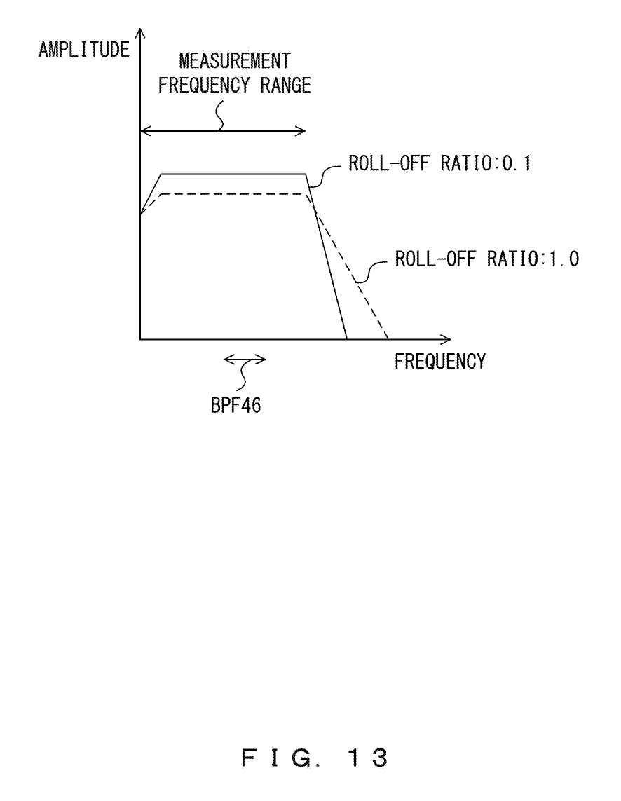

FIG. 13 illustrates an example of the spectrum of an output signal of the photodetector 42 in the third example. In the third example, the passband of the BPF 46 is specified within the measurement frequency range, as illustrated in FIG. 13. Therefore, similarly to the second example, the power of an output signal of the BPF 46 changes depending on the roll-off ratio. Accordingly, the control signal decision unit 45 can detect the control signal according to the output signal of the BPF 46. As described above, also in the third example, the control signal is detected according to a frequency component excluding a DC frequency component.

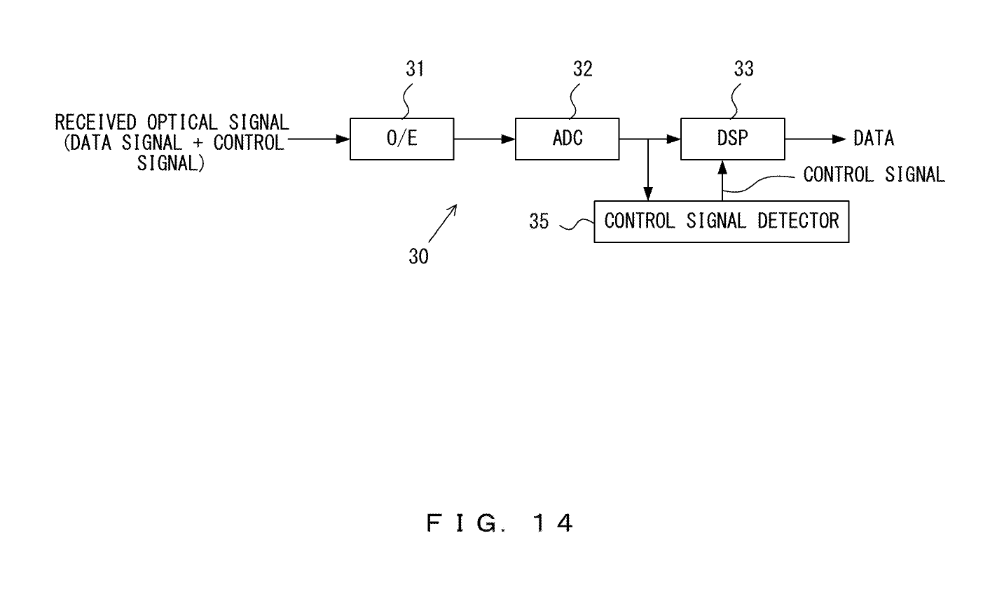

FIG. 14 illustrates another example of a receiver circuit implemented in a communication device according to the embodiments. This receiver circuit is implemented, for example, in the communication device 3 illustrated in FIG. 1.

A receiver circuit 30 illustrated in FIG. 14 includes an O/E circuit 31, an A/D converter (ADC) 32, a digital signal processor (DSP) 33, and a control signal detector 35. The receiver circuit 30 receives an optical signal generated by the transmitter circuit 10 illustrated in FIG. 2. This optical signal carries a data signal and a control signal. The control signal is converted into a change in the spectral shape of the optical signal.

The O/E circuit 31, the A/D converter 32, and the digital signal processor 33 are substantially the same in FIG. 8 and FIG. 14. Namely, the O/E circuit 31 converts a received optical signal into an electric signal. The A/D converter 32 converts an output signal of the O/E circuit 31 into a digital signal. The digital signal processor 33 recovers the data signal according to an output signal of the A/D converter 32 (namely, a digital signal indicating electric field information of the received optical signal).

The control signal detector 35 detects a change in the spectral shape of the received optical signal in accordance with the output signal of the A/D converter 32, and recovers the control signal in accordance with the change in the spectral shape. The control signal detector 35 gives the detected control signal to the digital signal processor 33. Control information transmitted by the control signal includes information indicating a bit rate, information indicating a modulation format, and the like, as described above. The digital signal processor 33 configures a parameter for signal processing in accordance with the control information. The function of the control signal detector 35 is implemented, for example, by a processor system including a processor and a memory.

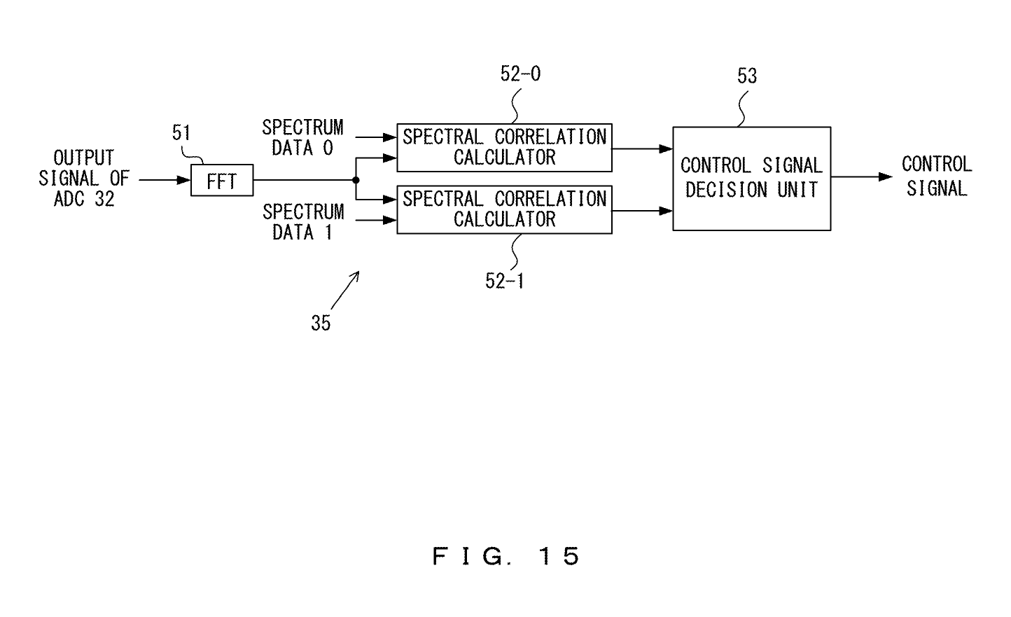

FIG. 15 illustrates a first example of the control signal detector 35 implemented in the receiver circuit 30 illustrated in FIG. 14. In the first example, the control signal detector 35 includes an FFT (Fast Fourier Transform) circuit 51, spectral correlation calculators 52-0 and 52-1, and a control signal decision unit 53.

The FFT circuit 51 performs FFT on an output signal of the A/D converter 32 so as to convert a received signal into a frequency domain signal. Namely, received spectrum data indicating the spectrum of the received signal is generated. The spectral correlation calculator 52-0 calculates a correlation between the received spectrum and spectrum data 0. The spectrum data 0 indicates the spectrum of a data signal obtained at the time when the control signal is “0”. Stated another way, the spectrum data 0 indicates the spectrum of a data signal obtained at the time when the roll-off ratio is 0.1. Meanwhile, the spectral correlation calculator 52-1 calculates a correlation between the received spectrum and spectrum data 1. The spectrum data 1 indicates the spectrum of a data signal obtained at the time when the control signal is “1”. Stated another way, the spectrum data 1 indicates the spectrum of a data signal obtained at the time when the roll-off ratio is 1.0. The spectrum data 0 and the spectrum data 1 are prepared in advance, and are stored in a memory that the control signal detector 35 can access.

The control signal decision unit 53 decides a value of the control signal according to correlation values calculated by the spectral correlation calculators 52-0 and 52-1. Specifically, when the correlation value calculated by the spectral correlation calculator 52-0 is greater than the correlation value calculated by the spectral correlation calculator 52-1, the control signal decision unit 53 decides that the control signal is “0”. When the correlation value calculated by the spectral correlation calculator 52-1 is greater than the correlation value calculated by the spectral correlation calculator 52-0, the control signal decision unit 53 decides that the control signal is “1”.

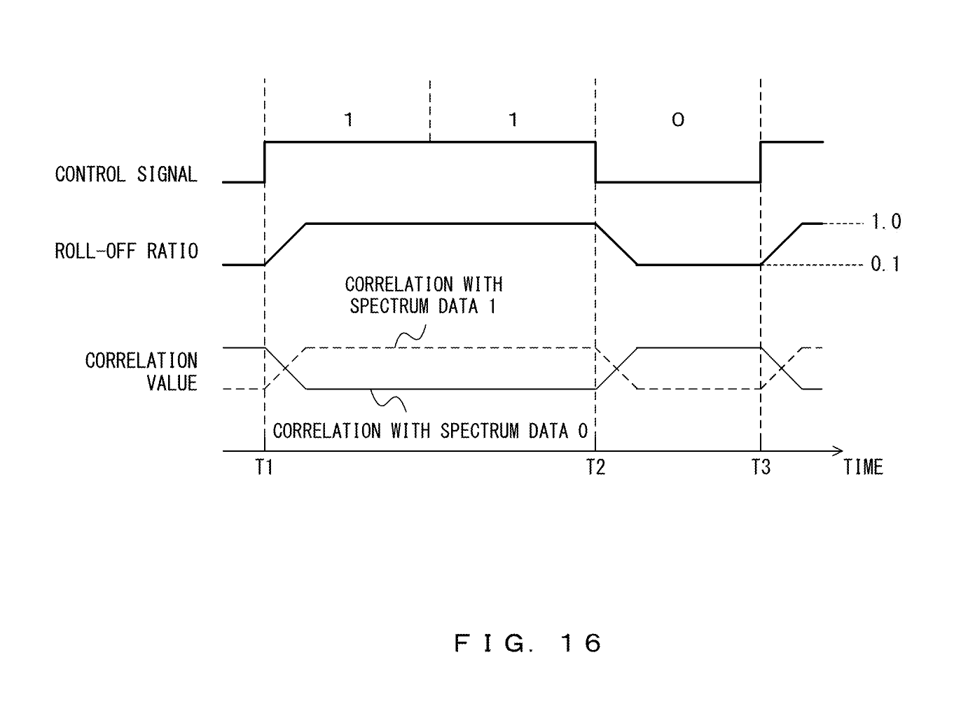

FIG. 16 is an example of a timing chart illustrating a correlation value with respect to a control signal. In this example, the control signal changes from “0” to “1” at time T1, changes from “1” to “0” at time T2, and changes from “0” to “1” at time T3. In this case, in the transmitter circuit 10, the roll-off ratio changes from 0.1 to 1.0 at time T1, changes from 1.0 to 0.1 at time T2, and changes from 0.1 to 1.0 at time T3.

During a period when the roll-off ratio is 1.0, the receiver circuit 30 receives a data signal of the spectrum illustrated in FIG. 3C. In this case, a correlation between the received spectrum and the spectrum data 1 is higher than a correlation between the received spectrum and the spectrum data 0. Accordingly, the control signal decision unit 53 decides that the control signal is “1”. Namely, during period T1-T2, the control signal detector 35 detects “1”.

During a period when the roll-off ratio is 0.1, the receiver circuit 30 receives a data signal of the spectrum illustrated in FIG. 3B. In this case, a correlation between the received spectrum and the spectrum data 0 is higher than a correlation between the received spectrum and the spectrum data 1. Accordingly, the control signal decision unit 53 decides that the control signal is “0”. Namely, during period T2-T3, the control signal detector 35 detects “0”.

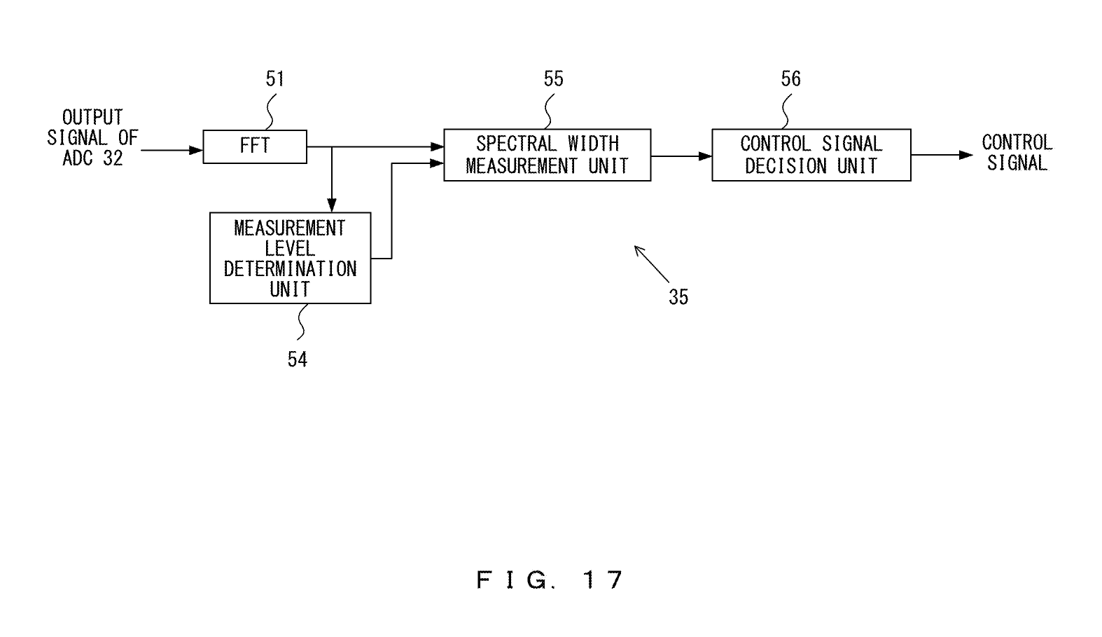

FIG. 17 illustrates a second example of the control signal detector 35 implemented in the receiver circuit 30 illustrated in FIG. 14. In the second example, the control signal detector 35 includes an FFT circuit 51, a measurement level determination unit 54, a spectral width measurement unit 55, and a control signal decision unit 56. The FFT circuit 51 performs FFT on an output signal of the A/D converter 32 so as to convert a received signal into a frequency domain signal, similarly to the first example illustrated in FIG. 15. Namely, received spectrum data indicating the spectrum of the received signal is generated.

The measurement level determination unit 54 detects the maximum power of the received signal by using the received spectrum data generated by the FFT circuit 51. The measurement level determination unit 54 determines a measurement level according to the maximum power. The spectral width measurement unit 55 measures the width of the spectrum of the received signal at the measurement level determined by the measurement level determination unit 54. The control signal decision unit 56 decides a value of the control signal according to the width of the spectrum measured by the spectral width measurement unit 55.

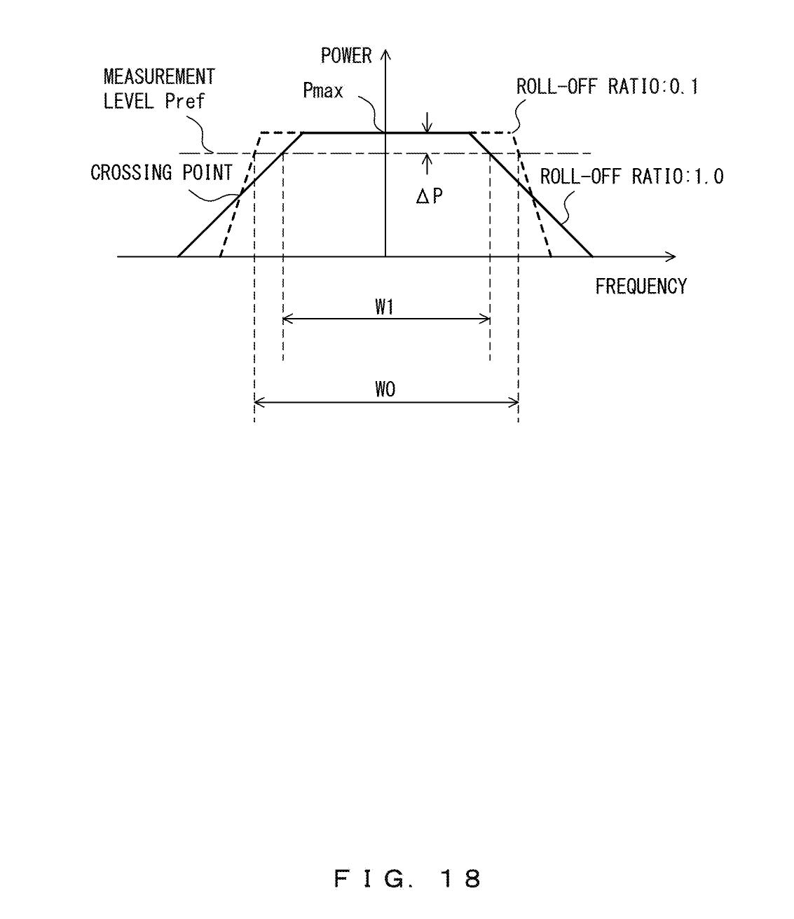

FIG. 18 illustrates an example of the measurement of a spectral width. In FIG. 18, the maximum power at the time when the roll-off ratio is 0.1 and the maximum power at the time when the roll-off ratio is 1.0 are the same in order to make the drawing easily viewable.

The measurement level determination unit 54 detects the maximum power Pₘₐₓ by using the received spectrum data generated by the FFT circuit 51. The measurement level determination unit 54 determines a measurement level P_{ref} from the maximum power Pₘₐₓ by using the formula below.

P_{ref}=Pₘₐₓ−ΔP

ΔP is several decibels, and is specified in advance. ΔP is determined such that the measurement level P_{ref} is higher than the crossing-point power. The crossing-point power refers to power at a frequency at which the end of a spectrum at the time when the roll-off ratio is 0.1 crosses the end of a spectrum at the time when the roll-off ratio is 1.0.

The spectral width measurement unit 55 measures the width of the spectrum of the received signal at the measurement level P_{ref}. In the example illustrated in FIG. 18, when the roll-off ratio is 0.1, the spectral width W0 is detected. When the roll-off ratio is 1.0, the spectral width W1 is detected. Note that the width W0 and the width W1 respectively depend on the bit rate of the data signal, a modulation format, and the like and can be calculated according to them.

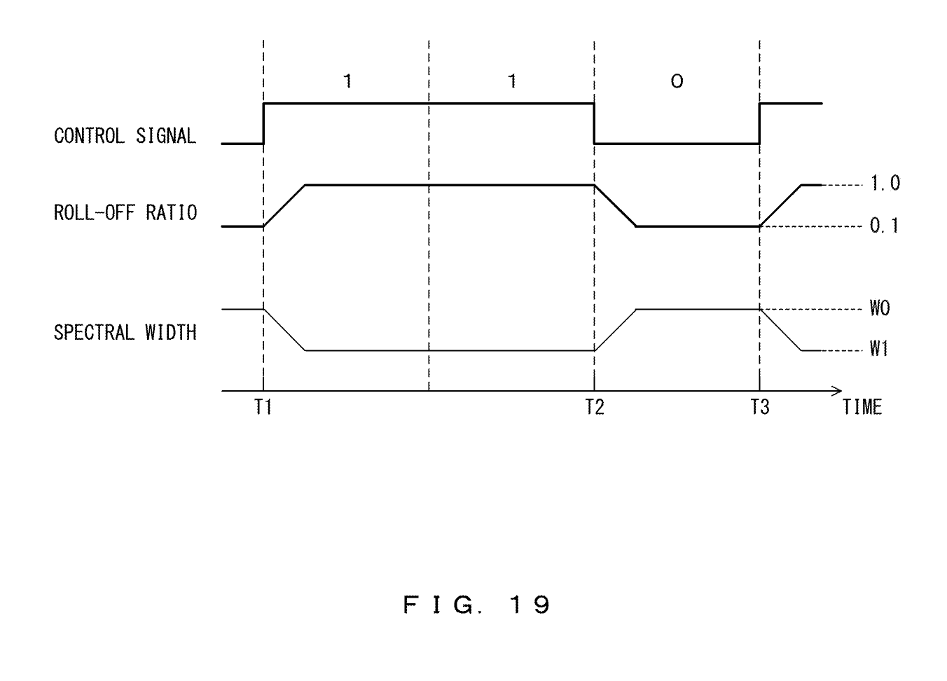

FIG. 19 is an example of a timing chart illustrating a spectral width with respect to a control signal. The control signal and the roll-off ratio are the same in FIG. 16 and FIG. 19.

During a period when the roll-off ratio is 1.0, the receiver circuit 30 receives a data signal of the spectrum illustrated with a solid line in FIG. 18. In this case, a spectral width detected by the spectral width measurement unit 55 is W1. Accordingly, the control signal decision unit 56 decides that the control signal is “1”. Stated another way, during period T1-T2, the control signal detector 35 detects “1”.

During a period when the roll-off ratio is 0.1, the receiver circuit 30 receives a data signal of the spectrum illustrated with a broken line in FIG. 18. In this case, a spectral width detected by the spectral width measurement unit 55 is W0. Accordingly, the control signal decision unit 56 decides that the control signal is “0”. Stated another way, during period T2-T3, the control signal detector 35 detects “0”.

The control signal decision unit 56 may decide a value of the control signal according to a comparison of the spectral width detected by the spectral width measurement unit 55 with a specified threshold. In this case, the threshold is determined, for example, by performing measurement, simulation, or the like.

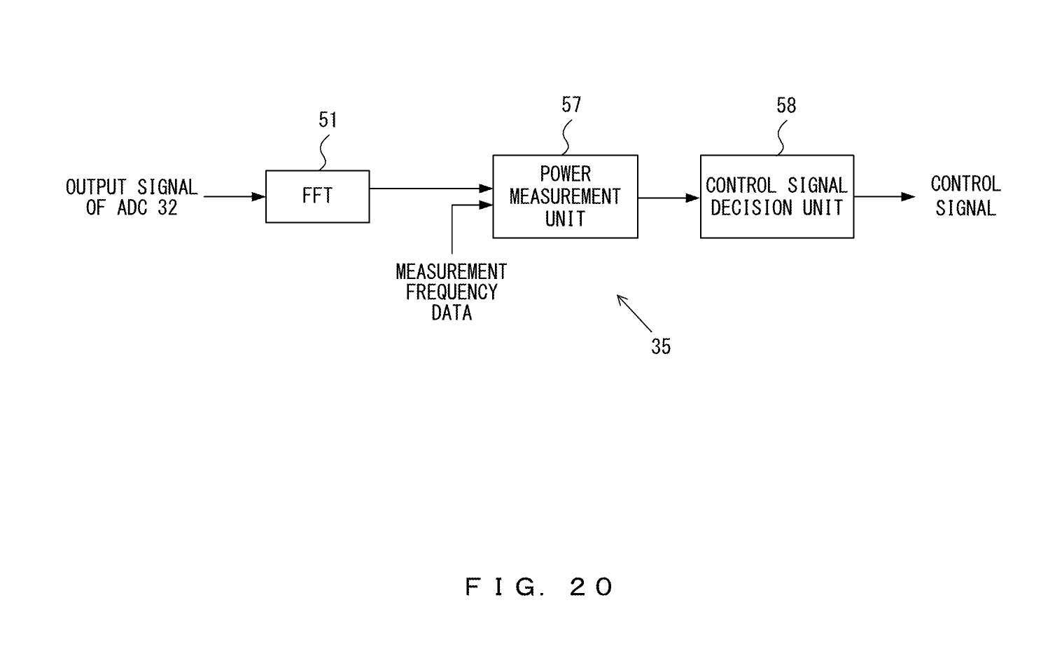

FIG. 20 illustrates a third example of the control signal detector 35 implemented in the receiver circuit 30 illustrated in FIG. 14. In the third example, the control signal detector 35 includes an FFT circuit 51, a power measurement unit 57, and a control signal decision unit 58. The FFT circuit 51 performs FFT on an output signal of the A/D converter 32 so as to convert a received signal into a frequency domain signal, similarly to the first example illustrated in FIG. 15. Namely, received spectrum data indicating the spectrum of the received signal is generated.

The power measurement unit 57 measures the power of the received signal at a specified measurement frequency by using the received spectrum data generated by the FFT circuit 51. The measurement frequency is specified by measurement frequency data. The measurement frequency data is generated in advance, for example, according to the bit rate of a data signal, a modulation format, and the like, and is given to the power measurement unit 57. The control signal decision unit 58 decides a value of the control signal according to the power measured by the power measurement unit 57.

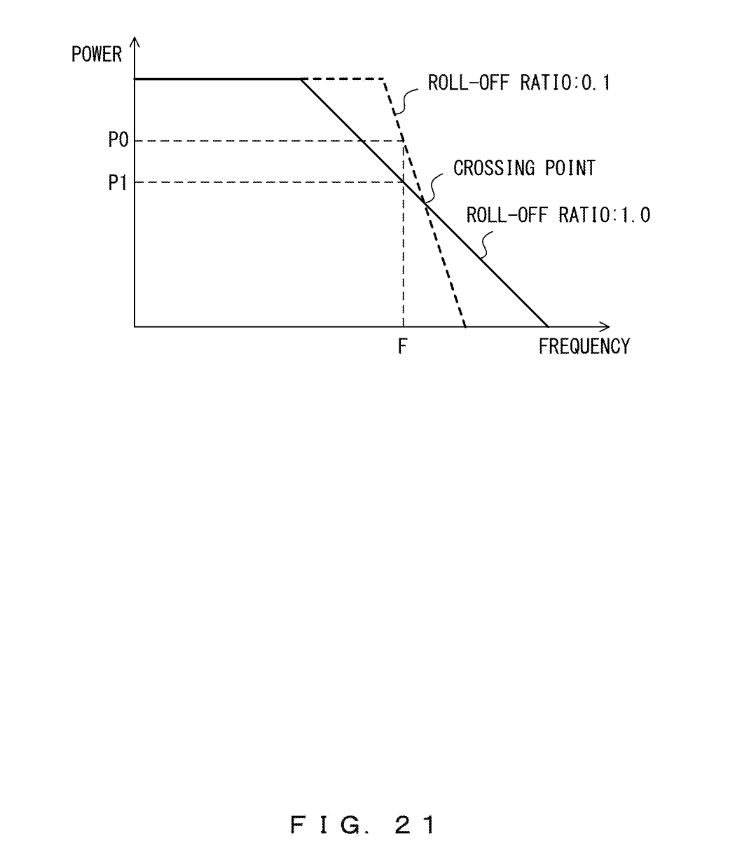

FIG. 21 illustrates an example of power measurement in the third example. In FIG. 21, the maximum power at the time when the roll-off ratio is 0.1 and the maximum power at the time when the roll-off ratio is 1.0 are the same in order to make the drawing easily viewable.

The power measurement unit 57 measures the power of a received signal at the measurement frequency F illustrated in FIG. 21. The measurement frequency F is specified within a frequency range in which the spectrum of the received signal is inclined with respect to a frequency. As an example, the measurement frequency F is a frequency at which a signal power that is higher than a crossing-point power is detected.

The power measurement unit 57 measures the power of the received signal at the measurement frequency F. In the example illustrated in FIG. 21, when the roll-off ratio is 0.1, the power P0 is detected. When the roll-off ratio is 1.0, the power P1 is detected.

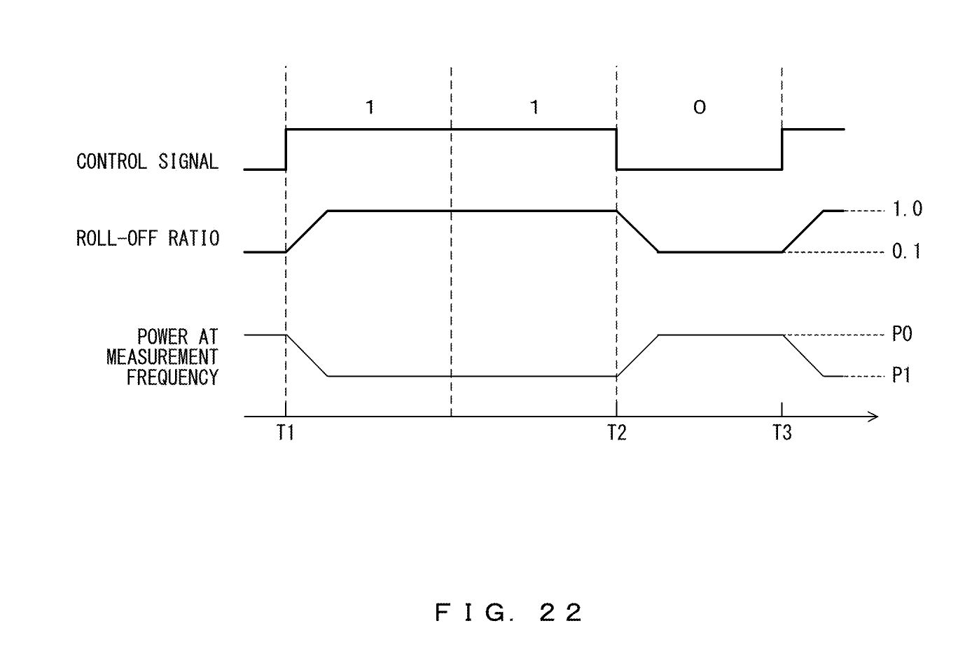

FIG. 22 is an example of a timing chart illustrating signal power with respect to a control signal. The control signal and the roll-off ratio are the same in FIG. 16 and FIG. 22.

During a period when the roll-off ratio is 1.0, the receiver circuit 30 receives a data signal of the spectrum illustrated with a solid line in FIG. 21. In this case, the power P1 is detected by the power measurement unit 57. Accordingly, the control signal decision unit 58 decides that the control signal is “1”. Stated another way, during period T1-T2, the control signal detector 35 detects “1”.

During a period when the roll-off ratio is 0.1, the receiver circuit 30 receives a data signal of the spectrum illustrated with a broken line in FIG. 21. In this case, the power P0 is detected by the power measurement unit 57. Accordingly, the control signal decision unit 58 decides that the control signal is “0”. Stated another way, during period T2-T3, the control signal detector 35 detects “0”.

The control signal decision unit 58 may decide a value of the control signal according to a comparison of the power detected by the power measurement unit 57 with a specified threshold. In this case, the threshold is determined, for example, by performing measurement, simulation, or the like.

In the examples illustrated in FIGS. 2-22, the control signal is a binary signal, but the embodiments are not limited to this configuration. Namely, the control signal may be a desired multi-level signal. As an example, the control signal is a quaternary (4-level) signal. In this case, a control signal of 2 bits is carried by using one symbol. As an example, when the control signals are “00”, “01, “10”, and “11”, the roll-off ratio is controlled to 0.1, 0.4, 0.7, and 1.0, respectively.

In the examples illustrated in FIGS. 2-22, the spectral shape of a data signal is controlled by using a Nyquist filter, but the embodiments are not limited to this configuration. Namely, the spectral shape of the data signal may be changed according to a control signal by using another method.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A communication device comprising:
a spectrum controller configured to control a shape of a spectrum of a first signal; and
an optical signal generator configured to generate an optical signal based on the first signal, the shape of the spectrum of the first signal being controlled by the spectrum controller, wherein
the spectrum controller controls the shape of the spectrum of the first signal according to a second signal.

2. The communication device according to claim 1, wherein
the spectrum controller includes:
a digital filter configured to filter the first signal; and
a filter controller configured to control filter coefficients of the digital filter according to the second signal.

3. The communication device according to claim 2, wherein
the filter controller changes characteristics of the digital filter from first characteristics to second characteristics through a plurality of stages when a state of the second signal changes from a first state to a second state.

4. The communication device according to claim 1, wherein
the spectrum controller includes:
a digital filter configured to control the spectrum of the first signal to be in a Nyquist shape; and
a filter controller configured to control filter coefficients of the digital filter according to the second signal.

5. The communication device according to claim 4, wherein
the filter controller controls a roll-off ratio of the digital filter according to the second signal.

6. The communication device according to claim 5, wherein
the filter controller changes the roll-off ratio of the digital filter from a first value to a second value through a plurality of stages when a state of the second signal changes from a first state to a second state.

7. A communication system including a first communication device and a second communication device that receives an optical signal transmitted from the first communication device, wherein
the first communication device comprising:
a spectrum controller configured to control a shape of a spectrum of a first signal; and
an optical signal generator configured to generate an optical signal based on the first signal, the shape of the spectrum of the first signal being controlled by the spectrum controller, wherein
the spectrum controller controls the shape of the spectrum of the first signal according to a second signal, and
the second communication device includes a signal detector configured to detect the second signal according to the shape of the spectrum of the optical signal.

8. The communication system according to claim 7, wherein
the signal detector includes:
a photodetector configured to convert the optical signal into an electric signal;
a filter configured to extract a portion of the spectrum of the electric signal that is output from the photodetector;
a power measurement unit configured to measure a power of an output signal of the filter; and
a signal decision unit configured to detect the second signal according to the power measured by the power measurement unit.

9. The communication system according to claim 7, wherein
the second communication device further includes:
a photodetector configured to convert the optical signal into an electric signal; and
an A/D (Analog-to-Digital) converter configured to convert the electric signal output from the photodetector into a digital signal, and wherein
the signal detector detects the second signal by monitoring a change in the shape of the spectrum of the optical signal by using the digital signal.

10. A communication method comprising:
determining filter coefficients of a digital filter that controls a shape of a spectrum of a first signal according to a second signal;
controlling, by the digital filter, the shape of the spectrum of the first signal by using the filter coefficients determined according to the second signal; and
generating an optical signal based on the first signal, the shape of the spectrum of the first signal being controlled by the digital filter.
